(19) United States
(12) Patent Application Publication
(10) Pub. No.: US 2007/0019514 A1
(43) Pub. Date: Jan. 25, 2007

(54) Lens driving and optical pickup device

(75) Inventor: Hiroshi Ogata, Higashihiroshima-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/493,457

(22) Filed: Jul. 25, 2006

(30) Foreign Application Priority Data
Jul. 25, 2005 (JP) JP2005-215008
Jul. 5, 2006 (JP) JP2006-186088

(51) Int. Cl. G11B 7/00

(52) U.S. Cl. 369/44.14

(57) ABSTRACT

The lens driving device according to the present invention concentrates a light beam emitted by a light source and reflected by a mirror onto a recording layer of a recording medium by use of an objective lens and includes an objective lens holding section for holding the objective lens so that the objective lens is movable in an optical axis direction, and the objective lens holding section is shaped so that the objective lens holding section is prevented from touching the mirror when the objective lens is made closer to the mirror. As a result, it is possible to reduce a space necessary for preventing the objective lens holding section from touching the mirror, so that it is possible to provide the lens driving device which is made thinner.

This non-provisional application claims priority under 35 U.S.C. § 119(a) on patent application Ser. No. 215008/2005 filed in Japan on Jul. 25, 2005 and patent application Ser. No. 186088/2006 filed in Japan on Jul. 5, 2006, the entire contents of which are hereby incorporated by reference.

### FIELD OF THE INVENTION

The present invention relates to (i) a lens driving device for driving an objective lens in an optical axis direction and in a direction perpendicular to the optical axis direction, the lens driving device being provided in an optical pickup device used in an optical recording/reproducing device for recording and/or reproducing optical information in and/or from a recording medium such as an optical disc, and (ii) an optical pickup device which includes the lens driving device.

### BACKGROUND OF THE INVENTION

Optical pickup devices have been used to record and reproduce information in and from recording media such as compact discs, laser discs, recordable or rewritable optical discs. Recordation and reproduction of information by use of the optical pickup devices are performed in such a manner that a light beam emitted by a light source is irradiated to a recordation/reproduction face of the recording medium and a reflective light from the recordation/reproduction face is used.

The optical pickup device includes a lens driving device which concentrates the light beam from the light source onto a recording layer of the recoding medium. The lens driving device includes an objective lens for concentrating a light beam onto the recording layer of the recoding medium and a lens folder for fixing the objective lens while the objective lens is movable.

In order to make the optical pickup device thin, a mirror for reflecting the light beam at 90 degrees is provided under the objective lens in the lens driving device and the light beam from the light source is reflected by the mirror and led to the objective lens (see Japanese Unexamined Patent Publication No. 107145/2005 (Tokukai 2005-107145; published on Apr. 21, 2005) for example).

FIG. 11 illustrates a conventional lens driving device. FIG. 11 is a cross sectional view of the conventional lens driving device taken in a line which passes through the central of the objective lens in a focus direction.

As illustrated in FIG. 11, the lens driving device causes the objective lens 6 to focus a light beam by moving a lens folder 107 in the focus direction.

In the mirror 12, a circumferential portion ranging from the circumference of the mirror to a point internally away from the circumference by approximately 0.3 mm is not used as a reflective face because the portion may have cracks generated in processing the mirror 12. Therefore, the mirror 12 included in the optical pickup device has a size which is a little broader than the width of the light beam incident to the mirror 12.

However, in the conventional arrangement, it is necessary to provide a space so that the portion of the mirror which portion is not used as the reflective face does not touch the objective lens holding section in the lens folder when the objective lens 6 is made closer to the mirror 12. Namely, the space should be made between the objective lens holding section and the mirror so that the objective lens holding section does not touch the mirror. This raises such a problem that it is difficult to make the optical pickup device thinner.

### SUMMARY OF THE INVENTION

An object of the present invention is to provide a lens driving device which allows reduction of a space necessary for preventing an objective lens holding section from touching a mirror, thereby making the lens driving device thinner.

In order to achieve the foregoing object, the lens driving device according to the present invention is a lens driving device, which concentrates a light beam emitted by a light source and reflected by a mirror onto a recording layer of a recording medium by use of an objective lens, including an objective lens holding section for holding the objective lens so that the objective lens is movable in an optical axis direction, wherein the objective lens holding section includes a cut portion for preventing the objective lens holding section from touching the mirror when the objective lens is made closer to the mirror.

With the arrangement, the objective lens holding section includes the cut portion, so that the objective lens can be positioned as close as possible to the reflective face of the mirror. Therefore, it is possible to reduce a space necessary for preventing the objective lens holding section from touching the mirror, so that it is possible to provide a lens driving device which is made thinner.

Further, the lens driving device according to the present invention is a lens driving device, which concentrates a light beam emitted by a light source and reflected by a mirror onto a recording layer of a recording medium by use of an objective lens, including: an objective lens holding section for holding the objective lens so that the objective lens is movable in an optical axis direction; and a waveplate for shifting a phase of the light beam reflected by the mirror, wherein the waveplate is disposed on the objective lens holding section so as to be positioned in a bottom face on a side of the mirror so that the waveplate does not touch the mirror when the objective lens is made closer to the mirror.

With the arrangement, the waveplate is disposed so that the waveplate does not touch the mirror when the objective lens is made closer to the mirror, so that the objective lens can be positioned closer to the reflective face of the mirror. As a result, it is possible to reduce a space necessary for preventing the objective lens holding section from touching the mirror, so that it is possible to provide a lens driving device which is made thinner.

In order to achieve the foregoing object, the optical pickup device according to the present invention includes the lens driving device.

Further, the optical pickup device according to the present invention is an optical pickup device, including: a mirror for reflecting a light beam emitted by a light source; a waveplate for shifting a phase of the light beam reflected by the mirror; and an objective lens for concentrating the light beam whose phase has been shifted by the waveplate onto a recording layer of a recording medium, wherein the mirror includes an end positioned close to the objective lens, and the waveplate includes (i) a mirror-summit-side end positioned close to the end of the mirror and (ii) a light-source-side end positioned opposite to the mirror-summit-side end, and the waveplate is disposed so that the light-source-side end is positioned closer in a focus direction to a bottom face of the mirror than the mirror-summit-side end of the waveplate.

With the arrangement, the lens driving device allows reduction of a space necessary for preventing the objective lens holding section from touching the mirror. Therefore, it is possible to provide an optical pickup device which is made thinner.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is an oblique view of a lens driving device according to the present embodiment at a time when an objective lens is positioned closest to a mirror.

FIG. 2 is a lateral view illustrating the lens driving device seen from a direction of an arrow A in FIG. 1.

FIG. 3 is a lateral view illustrating the lens driving device seen from a direction of an arrow B in FIG. 1.

FIG. 4 is an oblique view of the mirror.

FIG. 5 is a cross sectional view, illustrating the lens driving device in FIG. 1, which view is taken in a line passing through the central of the objective lens in a focus direction.

FIG. 6 is a cross sectional view, illustrating a lens driving device according to another embodiment at a time when an objective lens is positioned closest to a mirror, which view is taken in a line passing through the central of the objective lens in a focus direction.

FIG. 7 is a cross sectional view, illustrating a lens driving device according to further another embodiment at a time when an objective lens is positioned closest to a mirror, which view is taken in a line passing through the central of the objective lens in a focus direction.

FIG. 8 is a cross sectional view, illustrating a lens driving device according to further another embodiment at a time when an objective lens is positioned closest to a mirror, which view is taken in a line passing through the central of the objective lens in a focus direction.

FIG. 9 is a cross sectional view, illustrating a lens driving device according to further another embodiment at a time when an objective lens is positioned closest to a mirror, which view is taken in a line passing through the central of the objective lens in a focus direction.

FIG. 10 is a cross sectional view, illustrating a lens driving device according to further another embodiment at a time when an objective lens is positioned closest to a mirror, which view is taken in a line passing through the central of the objective lens in a focus direction.

FIG. 11 is a cross sectional view, illustrating a conventional lens driving device, which view is taken in a line passing through the central of the objective lens in a focus direction.

FIG. 12 is a cross sectional view, illustrating the conventional lens driving device at a time when the objective lens is positioned closest to a mirror, which view is taken in a line passing through the central of the objective lens in the focus direction.

### DESCRIPTION OF THE EMBODIMENTS

[Embodiment 1]

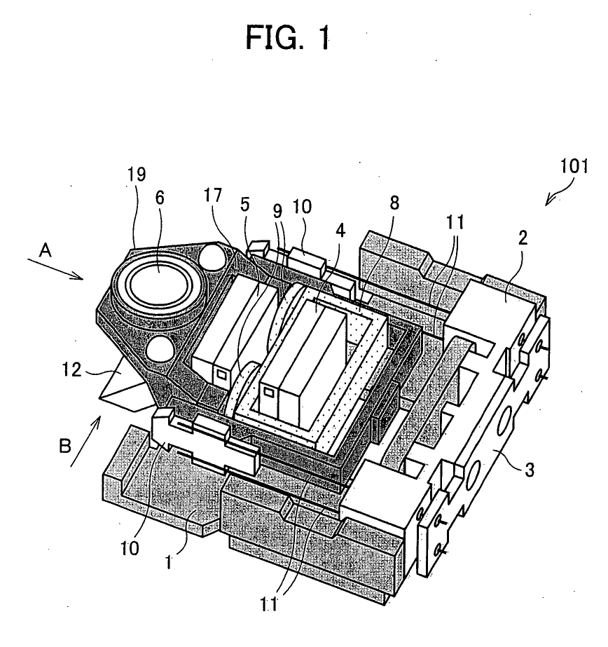

The following explains an embodiment of the present invention with reference to FIGS. 1 to 5 and 12.

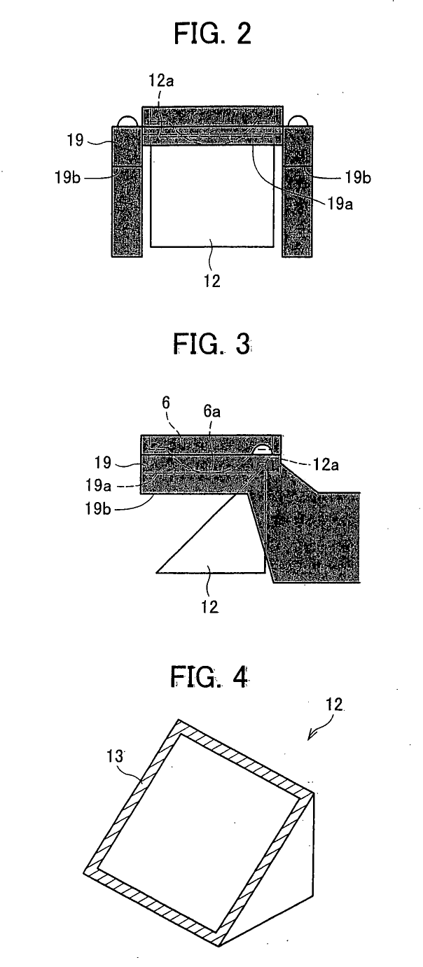

FIG. 1 is an oblique view of a lens driving device according to the present embodiment at a time when an objective lens is positioned closest to a mirror. FIG. 2 is a lateral view illustrating the lens driving device seen from a direction of an arrow A in FIG. 1. FIG. 3 is a lateral view illustrating the lens driving device seen from a direction of an arrow B in FIG. 1.

As illustrated in FIG. 1, a lens driving device 101 includes: a base section acting as a main body of the lens driving device 101; a lens movable section including an objective lens 6; and metal wires 11 for fixing the lens movable section with the base section.

The base section includes a base 1 and driving magnets 4 and 5. The lens movable section includes an objective lens 6, a lens folder 17, a focus coil 8, a tracking coil 9, and support substrates 10.

A spacer 2 is provided in the main body of an optical pickup device (not shown) and fixes the base 1 with the main body of the optical pickup device.

The base 1 is the main body of the base section. The driving magnets 4 and 5 appear to be quadrangle prisms and disposed in the base 1 so that the height direction of the quadrangle prism is parallel to the focus direction. The driving magnet 5 is disposed on the side of the objective lens 6 and the driving magnet 4 is disposed on the side of the spacer 2. The driving magnets 4 and 5 face each other so that they have polarities opposite to each other and attract each other. Namely, the driving magnets 4 and 5 are disposed so that a magnetic field is generated from one of the driving magnets 4 and 5 to the other. The driving magnets 4 and 5 operate together with the focus coil 8 and the tracking coil 9 in the lens movable section and drive the lens folder 17 in the focus direction and the tracking direction.

A support substrate 3 is disposed on the spacer 2 so as to be positioned in a backside of the side of the driving magnet 5. Through the optical pickup device, the support substrate 3 electrically connects the metal wires 11 with a driving control circuit of an optical recording/reproducing device (not shown) including the optical pickup device.

The lens folder 17 is the main body of the lens movable section and includes the objective lens 6, the focus coil 8, the tracking coil 9, and the support substrates 10. The lens folder 17 is fixed with the spacer 2 via the metal wires 11. The lens folder 17 has two holes which correspond to the driving magnets 4 and 5 included in the base 1.

Further, as illustrated in FIGS. 2 and 3, an objective lens holding section 19 in the lens holder 17 has, at its bottom face, a face 19a which faces the mirror 12. The bottom face of the objective lens holding section 19 except for the face 19a facing the mirror 12 (a face 19b which does not face the mirror 12) is positioned closer to the mirror 12 than the face 19a which faces the mirror 12. Namely, as illustrated in FIG. 2, when the lens folder 17 is seen from a direction in which the light beam is incident to the mirror 12 (an arrow A in FIG. 1), the objective lens holding section 19 has a three-sided shape which surrounds the end of the mirror 12 (an end 12a of the mirror 12 which end is positioned close to the objective lens 6).

The objective lens 6 is fixed with the end of the lens folder 17 so that an optical axis of the objective lens 6 is identical with an optical axis of a light beam reflected by the mirror 12, and the objective lens 6 concentrates the light beam onto a recording layer of a recording medium (not shown). Note that, the size of the objective lens is not particularly limited, but the size is preferably large enough to receive all the light beams reflected by the mirror 12.

The focus coil 8 is fixed with the lens folder 17 so as to be positioned in an end opposite to an end having the objective lens 6. The focus coil 8 is made of wire wound around axes parallel to the optical axis of the objective lens 6 and appears to be a hollow quadrangle prism. The focus coil 8 is disposed so that its hollow portion is identical with a hole corresponding to the driving magnet 4 included in the base 1. The focus coil 8 operates together with the driving magnets 4 and 5 and thus drives the objective lens 6 in the focus direction.

The tracking coil 9 is fixed on a side face of the focus coil 8 so as to be positioned on the side of the objective lens 6. The tracking coil 9 is made of wire wound around axes perpendicular to the optical axis of the objective lens 6. The tracking coil 9 operates together with the driving magnets 4 and 5 and thus drives the objective lens 6 in the tracking direction.

Each side face of the lens folder 17 has a support substrate 10 thereon so that the tracking coil 9 exists between one support substrate 10 and the other support substrate 10 in the tracking direction. The support substrates 10 supply power to the focus coil 8 and the tracking coil 9 via the metal wires 11.

The metal wires 11 are disposed between the support substrates 10 and the support substrate 3 so as to be substantially parallel to an axis perpendicular to the tracking direction. Each support substrate 10 has two metal wires 11 and therefore four metal wires 11 in total are disposed so as to be parallel to one another. As a result, the lens folder 17 can move in the focus direction and the tracking direction while the optical axis direction of the objective lens 6 does not change. Further, the metal wires 11 not only fix the lens movable section with the base section but also supply power to the focus coil 8 and the tracking coil 9 from the support substrate 3 via the support substrates 10.

Further, the mirror 12 is provided under the objective lens 6 in the lens driving device 101 so as to be positioned in the side receiving the light beam along with the optical axis direction of the objective lens 6.

The mirror 12 is fixed with the main body of the optical pickup device and is disposed so as to reflect the light beam at 90 degrees and to lead the light beam to the objective lens 6.

The following details the mirror 12 with reference to FIG. 4. FIG. 4 is an oblique view of the mirror 12.

As illustrated in FIG. 4, the mirror 12 has a rectangular equilateral triangular prism obtained by cutting a cube by a diagonal line and its cross section is a reflective face. Here, in the reflective face of the mirror 12, at a circumferential portion ranging from the circumference of the mirror 12 to a point internally away from the circumference by approximately 0.3 mm, there is a region 13 which cannot be used as the reflective face (the region is referred to as “unusable region” hereinafter). The unusable region 13 is a region which cannot be used as the reflective face because cracks may be generated in processing the mirror 12. As such, it is necessary to use the mirror 12 which is a little broader than the width of a light beam which is incident to the mirror 12.

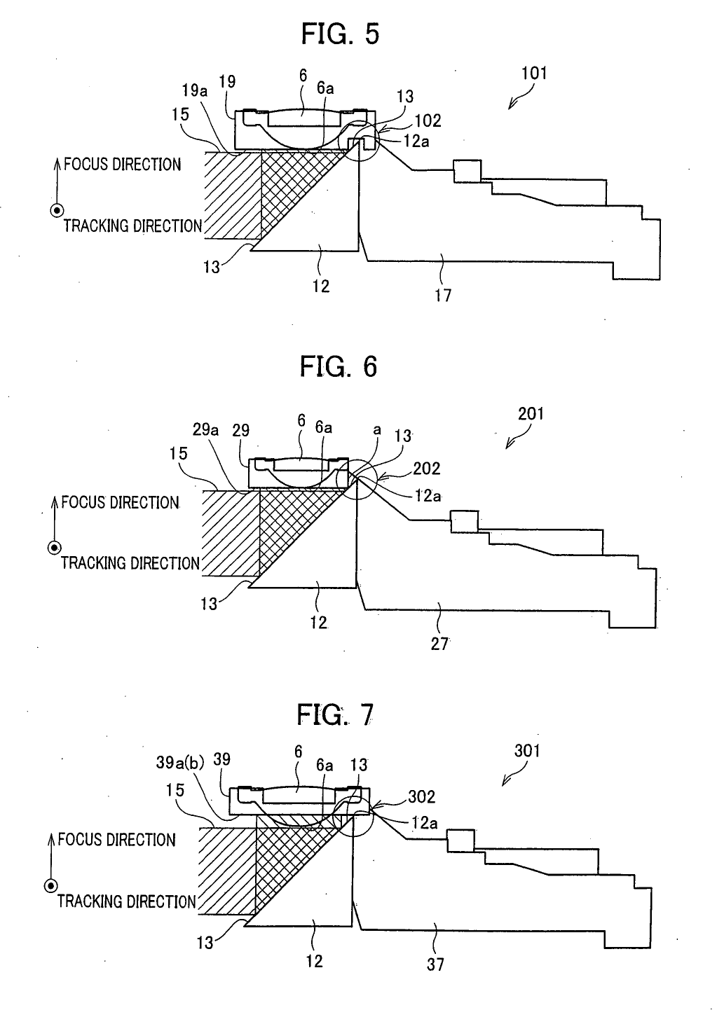

Next, with reference to FIGS. 5 and 12, the following explains an operation in which the objective lens 6 is driven in the focus direction by use of the lens folder 17.

FIG. 5 is a cross sectional view, illustrating the lens driving device 101 in FIG. 1, which view is taken in a line passing through the central of the objective lens 6 in the focus direction. FIG. 12 is a cross sectional view, illustrating a conventional lens driving device at a time when the objective lens 6 is positioned closest to the mirror 12, which view is taken in a line passing through the central of the objective lens 6 in the focus direction.

Note that, the light beam 15 in FIG. 5 includes: a light beam 15a which is emitted by a light source and not yet reflected by the mirror 12; a light beam 15b which is reflected by the mirror 12 and is incident to the objective lens 6; a light beam 15c which is reflected by the recording medium and is incident to the mirror 12 via the objective lens 6; and a light beam 15d which is reflected by the mirror 12 and is incident to the light source side.

As illustrated in FIG. 5, the lens driving device 101 according to the present embodiment concentrates the light beam 15b onto the recording layer of the recording medium by use of the objective lens 6, the light beam 15b being emitted by the light source, reflected by the mirror 12, and incident to the objective lens 6. When the lens driving device 101 concentrates the light beam 15b onto the recording layer of the recording medium by use of the objective lens 6, the lens driving device 101 drives the lens folder 17 in the tracking direction and the focus direction so that the light beam 15b always focuses on the recording layer of the recording medium.

As illustrated in FIG. 12, the conventional lens driving device has a space between the objective lens holding section 109 in the lens folder 107 and the mirror 12 so that the objective lens holding section 109 and the mirror 12 do not touch each other when the conventional lens driving device drives the lens folder 107 in the focus direction. This is because the mirror 12 has the unusable region 13. As such, between the objective lens 6 and the reflective face of the mirror 12, there must be provided a space at least having width W which is the width of the unusable region 13 in the focus direction. As a result, the conventional lens driving device must be thick so as to correspond to the width of the space in the focus direction.

On the other hand, as illustrated in FIG. 5, in the lens driving device 101, the objective lens holding section 19 has a cut portion so that the objective lens holding section 19 does not touch the mirror 12 when the lens driving device 101 drives the lens folder 17 in the focus direction. Namely, in the objective lens holding section 19, there is cut off a region facing an end of the mirror 12, which end includes the unusable region 13 (the end 12a of the mirror 12 which end is positioned close to the objective lens 6). As a result, the objective lens 6 can be positioned closer to the reflective face of the mirror 12.

More specifically, the cut portion has a concave shape when seen from the bottom face of the objective lens holding section, the bottom face being position on a side of the mirror. As a result, in a region 102 where the lens holder 17 is positioned closest to the mirror 12, the cut portion (space), i.e., the concave portion provided in the lens holder 19 allows the end of the mirror 12 which end includes the unusable region 13 (the end 12a of the mirror 12 which end is positioned close to the objective lens 6) to be stored therein. As a result, a summit 6a extending from the objective lens 6 toward the mirror 12 can be positioned lower in the focus direction than the end 12a of the mirror 12 which end 12a is positioned close to the objective lens 6 (can be positioned closer in the focus direction to the bottom face of the mirror 12), when the objective lens holding section 19 is positioned closest to the mirror 12. Therefore, the present embodiment allows the objective lens 6 to be positioned closer to the mirror 12, compared with a case where the cut portion is not provided in the objective lens holding section 19.

Particularly, in a case where the concave portion is longer in a direction perpendicular to both the focus direction and the tracking direction than the width of the unusable region 13 of the mirror 12, the objective lens 6 can be positioned as close as possible to the reflective face of the mirror 12, namely, can be positioned closest to the mirror 12 on condition that the objective lens 6 does not block (i) the light beam 15a which is emitted by the light source and not yet reflected by the mirror 12 and (ii) the light beam 15d having been reflected by the recording medium, passed through the objective lens 6, and been reflected by the mirror 12. As such, the case is more preferable.

In this way, simple modification of the objective lens holding section 19 allows the space necessary for preventing the objective lens holding section 19 from touching the mirror 12 to be easily reduced. As a result, it is easy to make the lens driving device 101 thinner.

As described above, in the lens driving device 101 according to the present invention, it is possible to reduce the space necessary for preventing the objective lens holding section 19 from touching the mirror 12. As a result, it is possible to make the lens driving device 101 thin by a thickness corresponding to a reduced space. As a result, it is possible to provide the lens driving device 101 which is made thinner. Further, it is possible to realize an optical pickup device which is made thinner, by providing the lens driving device 101 according to the present invention in the optical pickup device.

[Embodiment 2]

The following details Embodiment 2 according to the present invention with reference to FIG. 6. Note that, members being the same as the members in Embodiment 1 are given the same reference numbers and explanations thereof are omitted here.

The lens driving device according to Embodiment 2 is formed in the same manner as the lens driving device according to Embodiment 1 except that a lens folder 27 is used instead of the lens folder 17.

With reference to FIG. 6, the following explains an operation in which the objective lens 6 is driven in a focus direction by use of the lens folder 27.

FIG. 6 is a cross sectional view, illustrating a lens driving device according to the present embodiment at a time when an objective lens holding section is positioned closest to the mirror, which view is taken in a line passing through the central of the objective lens in the focus direction.

As illustrated in FIG. 6, in a lens driving device 201, an objective lens holding section 29 in the lens folder 27 has a cut portion so that the objective lens holding section 29 does not touch the mirror 12 when the lens driving device 201 drives the lens folder 27 in the focus direction. Namely, in the objective lens holding section 29, there is cut off a region facing an end of the mirror 12, which end includes the unusable region 13 (the end 12a of the mirror 12 which is positioned close to the objective lens 6). As a result, the objective lens 6 can be positioned closer to the reflective face of the mirror 12.

To be specific, the cut portion is provided so that a cut face a is parallel to the focus direction. Namely, the width of the objective lens holding section 29 in a direction perpendicular to the tracking direction becomes short, and accordingly the objective lens holding section 29 has such an end positioned on the side of the mirror 12 in the direction perpendicular to the tracking direction that the end becomes closer to the objective lens 6.

As a result, in a region 202 where the lens folder 27 is positioned closest to the mirror 12, the lens holder 29 allows the end of the mirror 12 which end includes the unusable region 13 (the end 12a of the mirror 12 which end is positioned close to the objective lens 6) to be stored in a space made by providing the cut portion. As a result, a summit 6a extending from the objective lens 6 toward the mirror 12 can be positioned lower in the focus direction than the end 12a of the mirror 12 which end 12a is positioned close to the objective lens 6 (can be positioned closer to the bottom face of the mirror 12), when the objective lens holding section 29 is positioned closest to the mirror 12. Therefore, the present embodiment allows the objective lens 6 to be positioned closer to the mirror 12, compared with a case where the cut portion is not provided in the objective lens holding section 29.

Particularly, in a case where the width of the space made by providing the cut portion is longer in a direction perpendicular to the tracking direction than the width of the unusable region 13 of the mirror 12, the objective lens 6 can be positioned as close as possible to the reflective face of the mirror 12, namely, can be positioned closest to the mirror 12 on condition that the objective lens 6 does not block (i) the light beam 15a which is emitted by the light source and not yet reflected by the mirror 12 and (ii) the light beam 15d having been reflected by the recording medium, passed through the objective lens 6, and been reflected by the mirror 12. As such, the case is more preferable.

In this way, simple modification of the objective lens holding section 29 allows the space necessary for preventing the objective lens holding section 29 from touching the mirror 12 to be easily reduced. As a result, it is easy to make the lens driving device 201 thinner without greatly increasing fabrication processes and fabrication costs.

As described above, in the lens driving device. 201 according to the present invention, it is possible to reduce the space necessary for preventing the objective lens holding section 29 from touching the mirror 12. As a result, it is possible to make the lens driving device 201 thin by a thickness corresponding to a reduced space. As a result, it is possible to provide the lens driving device 201 which is made thinner. Further, it is possible to realize an optical pickup device which is made thinner, by providing the lens driving device 201 according to the present invention in the optical pickup device.

[Embodiment 3]

The following details Embodiment 3 according to the present invention with reference to FIG. 7. Note that, members being the same as the members in Embodiment 1 are given the same reference numbers and explanations thereof are omitted here.

The lens driving device according to Embodiment 3 is formed in the same manner as the lens driving device according to Embodiment 1 except that a lens folder 37 is used instead of the lens folder 17.

With reference to FIG. 7, the following explains an operation in which the objective lens 6 is driven in a focus direction by use of the lens folder 37.

FIG. 7 is a cross sectional view, illustrating a lens driving device according to the present embodiment at a time when an objective lens is positioned closest to the mirror, which view is taken in a line passing through the central of the objective lens in the focus direction.

As illustrated in FIG. 7, in a lens driving device 301, an objective lens holding section 39 in the lens folder 37 has a cut portion so that the objective lens holding section 39 does not touch the mirror 12 when the lens driving device 301 drives the lens folder 37 in the focus direction. Namely, in the objective lens holding section 39, there is cut off a region facing an end of the mirror 12, which end includes the unusable region 13 (the end 12a of the mirror 12 which end is positioned close to the objective lens 6). As a result, the objective lens 6 can be positioned closer to the reflective face of the mirror 12.

To be specific, the cut portion is provided so that a cut face b is parallel to the tracking direction. Namely, the cut face b is provided so as to be a face 39a which faces the mirror 12. As a result, the width of the objective lens holding section 39 in the focus direction becomes short, and accordingly the objective lens 6 protrudes from the bottom face of the objective lens holding section 39 (the face 39a which faces the mirror 12) toward the mirror 12.

As a result, in a region 302 where the lens folder 37 is positioned closest to the mirror 12, the lens holder 39 allows the end of the mirror 12 which end includes the unusable region 13 (the end 12a of the mirror 12 which end is positioned close to the objective lens 6) to be stored in a space made by providing the cut portion. As a result, a summit 6a extending from the objective lens 6 toward the mirror 12 can be positioned lower in the focus direction than the end 12a of the mirror 12 which end 12a is positioned close to the objective lens 6 (can be positioned closer to the bottom face of the mirror 12), when the objective lens holding section 39 is positioned closest to the mirror 12. Therefore, the present embodiment allows the objective lens 6 to be positioned closer to the mirror 12, compared with a case where the cut portion is not provided in the objective lens holding section 39.

Particularly, in a case where the width of the space made by providing the cut portion is longer in the focus direction than the width of the unusable region 13 of the mirror 12, the objective lens 6 can be positioned as close as possible to the reflective face of the mirror 12, namely, can be positioned closest to the mirror 12 on condition that the objective lens 6 does not block (i) the light beam 15a which is emitted by the light source and not yet reflected by the mirror 12 and (ii) the light beam 15d having been reflected by the recording medium, passed through the objective lens 6, and been reflected by the mirror 12. As such, the case is more preferable.

In this way, simple modification of the objective lens holding section 39 allows the space necessary for preventing the objective lens holding section 39 from touching the mirror 12 to be easily reduced. As a result, it is easy to make the lens driving device 301 thinner without greatly increasing fabrication processes and fabrication costs.

As described above, in the lens driving device 301 according to the present invention, it is possible to reduce the space necessary for preventing the objective lens holding section 39 from touching the mirror 12. As a result, it is possible to make the lens driving device 301 thin by a thickness corresponding to a reduced space. As a result, it is possible to provide the lens driving device 301 which is made thinner. Further, it is possible to realize an optical pickup device which is made thinner, by providing the lens driving device 301 according to the present invention in the optical pickup device.

[Embodiment 4]

The following details Embodiment 4 according to the present invention with reference to FIG. 8. Note that, members being the same as the members in Embodiment 1 are given the same reference numbers and explanations thereof are omitted here.

The lens driving device according to Embodiment 4 is formed in the same manner as the lens driving device according to Embodiment 1 except that a lens folder 47 is used instead of the lens folder 17 and the lens folder 47 includes a waveplate 18.

FIG. 8 is a cross sectional view, illustrating a lens driving device according to the present embodiment at a time when an objective lens is positioned closest to the mirror, which view is taken in a line passing through the central of the objective lens in the focus direction.

The waveplate 18 is provided on an objective lens holding section 49 in the lens folder 47 so as to be positioned on the side of the mirror 12. The waveplate 18 has a plate shape whose bottom is a quadrangle. The waveplate 18 shifts the phase of the light beam 15b from the mirror 12 and the phase of the light beam 15c reflected by the recording layer of the recording medium.

As illustrated in FIG. 8, a lens driving device 401 causes the waveplate 18 to shift the phase of the light beam 15b having been emitted by the light source, been reflected by the mirror 12, and been incident to the waveplate 18, and the lens driving device 401 causes the objective lens 6 to concentrate the light beam 15b onto the recording layer of the recording medium. When the lens driving device 401 causes the objective lens 6 to concentrate the light beam 15b onto the recoding layer of the recording medium, the lens driving device 401 drives the lens folder 47 in the tracking direction and the focus direction so that the light beam 15b always focuses on the recording layer of the recording medium.

The following explains an operation in which the objective lens 6 is driven in the focus direction by use of the lens folder 47.

As illustrated in FIG. 8, in the lens driving device 401, the objective lens holding section 49 in the lens folder 47 is shaped so that the objective lens holding section 49 does not touch the mirror 12 when the lens driving device 401 drives the lens folder 47 in the focus direction. Namely, in the objective lens holding section 49, a region where the waveplate 18 is to be provided is cut off and thus the waveplate 18 is inclined so that its end 18a at the summit side of the mirror 12 (mirror-summit-side end) is positioned closer in the focus direction to the objective lens 6 than its end 18b at the light source side (the incident side where the light beam emitted by the light source is incident) (light-source-side end), the end 18b being positioned opposite to the end 18a at the summit side of the mirror 12. As a result, the waveplate 18 is inclined so that an in-plane direction of the waveplate 18 is not perpendicular to the optical axis of the light beam 15b which is incident to the objective lens 6. Namely, the waveplate 18 is inclined in such a direction that the end of the waveplate 18 which end is closer to the mirror 12 (the end 18a at the summit side of the mirror 12) is made away from the mirror 12. As a result, it is possible to make the objective lens 6 closer to the reflective face of the mirror 12.

As a result, in a region 402 where the lens folder 47 is positioned closest to the mirror 12, the objective lens holding section 49 allows the end of the mirror 12 which end includes the unusable region 13 (the end 12a of the mirror 12 which end is positioned close to the objective lens 6) to be stored in a space made by providing the waveplate 18 so that the waveplate 18 is inclined. As a result, the end 18b of the waveplate 18 at the light source side can be positioned lower in the focus direction than the end 12a of the mirror 12 which end 12a is positioned close to the objective lens 6 (can be positioned closer to the bottom face of the mirror 12), when the objective lens holding section 49 is positioned closest to the mirror 12. Therefore, the present embodiment allows the objective lens 6 to be positioned closer to the mirror 12.

Particularly, in a case where the width of the space made by providing the waveplate 18 so that the waveplate 18 is inclined is longer in the focus direction than the width of the unusable region 13 of the mirror 12, the objective lens 6 can be positioned as close as possible to the reflective face of the mirror 12, namely, can be positioned closest to the mirror 12 on condition that the waveplate 18 does not block (i) the light beam 15a which is emitted by the light source and not yet reflected by the mirror 12 and (ii) the light beam 15d having been reflected by the recording medium, passed through the objective lens 6, and been reflected by the mirror 12. As such, the case is more preferable.

Note that, the inclination of the waveplate 18 is not particularly limited as long as the waveplate 18 does not block (i) the light beam 15a which is emitted by the light source and not yet reflected by the mirror 12 and (ii) the light beam 15d having been reflected by the recording medium, passed through the objective lens 6, and been reflected by the mirror 12. The inclination of the waveplate 18 is suitably set in accordance with the size of the waveplate 18, the condition under which the light beam 15 is incident, or a similar condition.

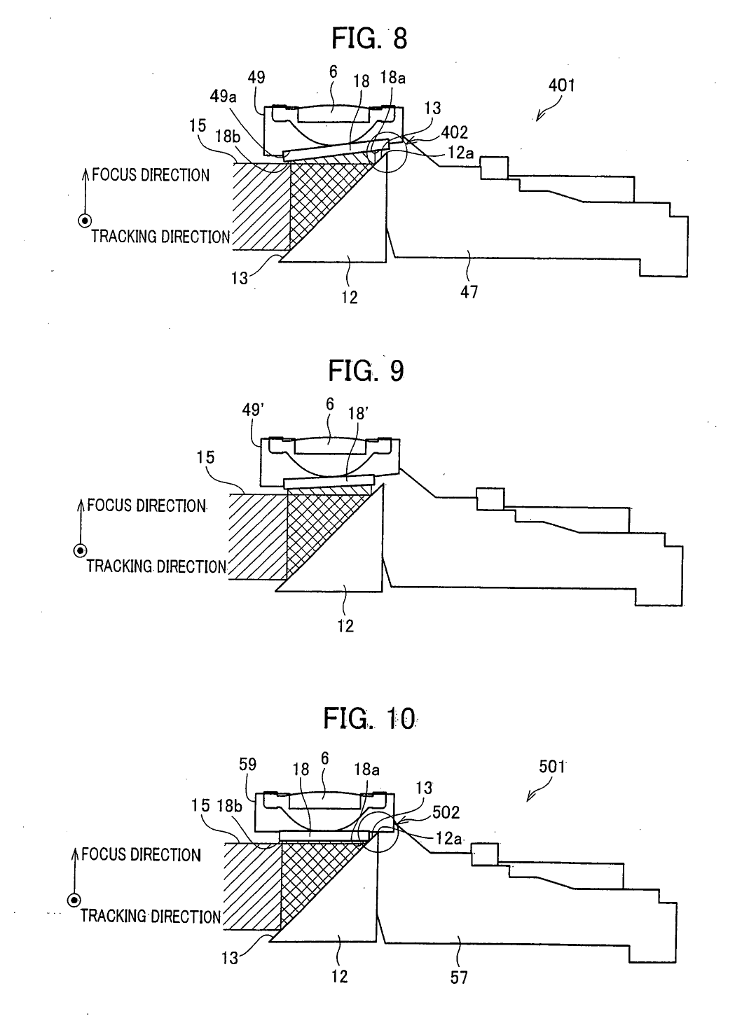

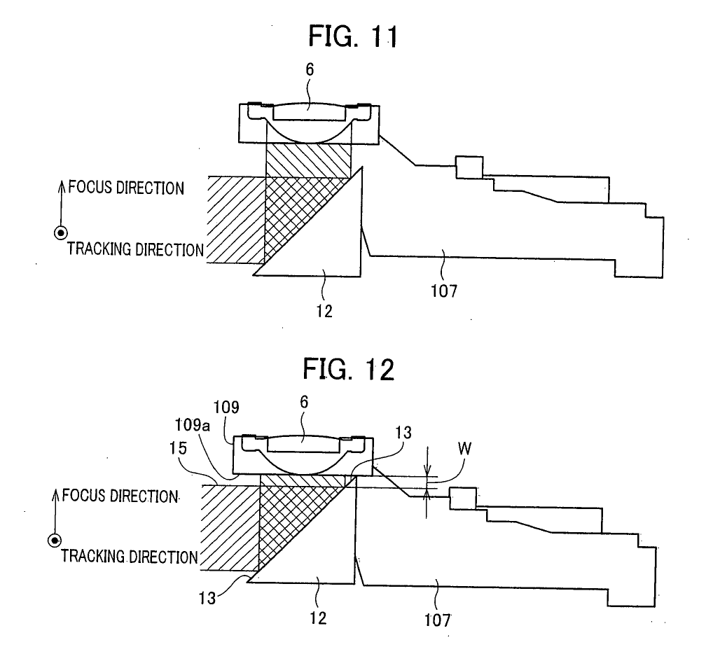

With reference to FIG. 9, the following explains an example of the inclination of the waveplate 18. FIG. 9 is a cross sectional view, illustrating a lens driving device including a waveplate 18′ at a time when the objective lens 6 is positioned closest to the mirror 12, which view is taken in a line which passes through the central of the objective lens 6 in the focus direction.

As illustrated in FIG. 9, in a case where the waveplate 18′ which is shorter in width (smaller in area) than the waveplate 18 in the lens driving device 401 is used, when the waveplate 18′ is disposed on the lens holder 49′ with the same inclination as that of the waveplate 18, the waveplate 18′ cannot receive all of the light beams 15b having been emitted by the light source and reflected by the mirror 12. Therefore, as illustrated in FIG. 9, it is necessary to dispose the waveplate 18′ with inclination which is smaller than the inclination of the waveplate 18.

Further, in the present embodiment, by adjusting the size of the waveplate 18 to be used or the inclination of the waveplate 18, the objective lens 6 is made closer to the reflective face of the mirror 12. As a result, it is not necessary to make the size of the waveplate 18 as small as possible corresponding to the light beam, so that it is not necessary to exactly adjust the position of the waveplate 18 corresponding to the light beams 15b and 15c. Therefore, it is possible to make the lens driving device 401 thin without increasing fabrication costs.

In this way, simple modification of the objective lens holding section 49 allows the space necessary for preventing the objective lens holding section 49 from touching the mirror 12 to be easily reduced. As a result, it is easy to make the lens driving device 401 thinner, without increasing fabrication steps and fabrication costs.

As described above, in the lens driving device 401 according to the present invention, it is possible to reduce a space necessary for preventing the objective lens holding section 49 from touching the mirror 12. As a result, it is possible to make the lens driving device 401 thin by a thickness corresponding to a reduced space. As a result, it is possible to provide the lens driving device 401 which is made thinner. Further, it is possible to realize an optical pickup device which is made thinner, by providing the lens driving device 401 according to the present invention in the optical pickup device.

Note that, the foregoing explains a case of using the objective lens holding section 49 in which only a region touching the waveplate 18 is cut off so that the waveplate 18 is inclined. However, the present invention is not limited to this case. For example, the lens holder 39 described in Embodiment 3, in which a region is cut off in parallel to the tracking direction, may be used. At that time, if it is possible to incline the waveplate 18 by cutting the bottom face of the lens holder 39, substantially the same effect as the present embodiment can be obtained.

[Embodiment 5]

The following details Embodiment 5 according to the present invention with reference to FIG. 10. Note that, members being the same as the members in Embodiments 1 and 4 are given the same reference numbers and explanations thereof are omitted here.

The lens driving device according to Embodiment 5 is formed in the same manner as the lens driving device according to Embodiment 4 except that a lens folder 57 is used instead of the lens folder 47.

With reference to FIG. 10, the following explains an operation in which the objective lens 6 is driven in the focus direction by use of the lens folder 57.

FIG. 10 is a cross sectional view, illustrating a lens driving device according to the present embodiment at a time when an objective lens is positioned closest to the mirror, which view is taken in a line passing through the central of the objective lens in the focus direction.

As illustrated in FIG. 10, in a lens driving device 501, the waveplate 18 is disposed on the objective lens holding section 59 so as to be positioned in the bottom face on the side of the mirror 12 so that the waveplate 18 does not touch the mirror 12 when the objective lens 6 is made closer to the mirror 12. As a result, it is possible to make the objective lens 6 closer to the reflective face of the mirror 12.

To be specific, the waveplate 18 is disposed so that its end positioned on the side of the mirror 12 (the end 18a at the summit side of the mirror 12) is slid away from the mirror 12 in a direction perpendicular to the tracking direction so as to avoid the end of the mirror 12 which end includes the unusable region 13 (the end 12a of the mirror 12 which end is positioned close to the objective lens 6).

As a result, in a region 502 where the lens folder 57 is positioned closest to the mirror 12, the lens driving device 501 allows the end of the mirror 12 which end includes the unusable region 13 (the end 12a of the mirror 12 which end is positioned close to the objective lens 6) to be stored in a space made by providing the waveplate 18 so that the waveplate 18 is slid. As a result, the bottom face of the waveplate 18 can be positioned lower in the focus direction than the end 12a of the mirror 12 which end 12a is positioned close to the objective lens 6 (can be positioned closer to the bottom face of the mirror 12), when the objective lens holding section 59 is positioned closest to the mirror 12. Therefore, the present embodiment allows the objective lens 6 to be positioned closer to the mirror 12, compared with a case where the waveplate 18 is not provided in such a manner that the waveplate 18 does not contact with the mirror 12.

Particularly, in a case where the width of the space made by providing the waveplate 18 so that the waveplate 18 is slid is longer in a direction perpendicular to the tracking direction than the width of the unusable region 13 of the mirror 12, the objective lens 6 can be positioned as close as possible to the reflective face of the mirror 12, namely, can be positioned closest to the mirror 12 on condition that the waveplate 18 does not block (i) the light beam 15a which is emitted by the light source and not yet reflected by the mirror 12 and (ii) the light beam 15d having been reflected by the recording medium, passed through the objective lens 6, and been reflected by the mirror 12. As such, the case is more preferable.

In this way, simple modification of the objective lens holding section 59 allows the space necessary for preventing the objective lens holding section 59 from touching the mirror 12 to be easily reduced. As a result, it is easy to make the lens driving device 501 thinner, without increasing fabrication steps and fabrication costs.

As described above, in the lens driving device 501 according to the present invention, it is possible to reduce the space necessary for preventing the objective lens holding section 59 from touching the mirror 12. As a result, it is possible to make the lens driving device 501 thin by a thickness corresponding to a reduced space. As a result, it is possible to provide the lens driving device 501 which is made thinner. Further, it is possible to realize an optical pickup device which is made thinner, by providing the lens driving device 501 according to the present invention in the optical pickup device.

Note that, Embodiments 1 to 5 describe the mirror 12 as being a rectangular equilateral triangular prism. However, the mirror 12 is not limited to the rectangular equilateral triangular prism. For example, the mirror 12 may have a flat shape. As long as the mirror 12 can reflect the light beam 15a emitted by the light source and conduct the light beam 15 to the objective lens 6, the mirror 12 having any shape can obtain substantially the same effect as Embodiments 1 to 5.

Further, Embodiments 4 and 5 describe the waveplate 18 as being a plate whose bottom face is a quadrangle. However, the waveplate 18 is not limited to the plate whose bottom face is a quadrangle. For example, the waveplate 18 may be a plate whose bottom face is round. As long as the waveplate 18 can receive all light beams 15b having been emitted by the light source and reflected by the mirror 12, even though the size of the waveplate 18 or the shape of the bottom face of the waveplate 18 varies, it is possible to obtain substantially the same effect as Embodiments 4 and 5.

Further, in Embodiments 1 to 5, a case where a member for leading the light beam 15a emitted by the light source to the lens driving device is the mirror 12 is explained. However, the present invention is not limited to this case. For example, the member may be a beam splitter. When the member for leading the light beam 15a emitted by the light source to the lens driving device is a beam splitter, it is possible to obtain substantially the same effect as Embodiments 1 to 5.

The present invention is not limited to the foregoing embodiments, and a variety of modifications are possible within the scope specified by claims. Embodiments obtained by combining technical means disclosed in different embodiments are also included in technical scope of the present invention.

As described above, the lens driving device according to the present invention is a lens driving device, which concentrates a light beam emitted by a light source and reflected by a mirror onto a recording layer of a recording medium by use of an objective lens, including an objective lens holding section for holding the objective lens so that the objective lens is movable in an optical axis direction, wherein the objective lens holding section includes a cut portion for preventing the objective lens holding section from touching the mirror when the objective lens is made closer to the mirror.

As a result, the objective lens can be positioned as close as possible to the reflective face of the mirror. Therefore, it is possible to reduce a space necessary for preventing the objective lens holding section from touching the mirror, so that it is possible to provide a lens driving device which is made thinner.

Further, the lens driving device according to the present invention is a lens driving device, which concentrates a light beam emitted by a light source and reflected by a mirror onto a recording layer of a recording medium by use of an objective lens, including: an objective lens holding section for holding the objective lens so that the objective lens is movable in an optical axis direction; and a waveplate for shifting a phase of the light beam reflected by the mirror, wherein the waveplate is disposed on the objective lens holding section so as to be positioned in a bottom face on a side of the mirror so that the waveplate does not touch the mirror when the objective lens is made closer to the mirror.

With the arrangement, the waveplate is disposed so that the waveplate does not touch the mirror when the objective lens is made closer to the mirror, so that the objective lens can be positioned closer to the reflective face of the mirror. As a result, it is possible to reduce a space necessary for preventing the objective lens holding section from touching the mirror, so that it is possible to provide a lens driving device which is made thinner.

It is preferable to arrange the lens driving device according to the present invention so that the objective lens holding section includes a cut portion for preventing the objective lens holding section from touching the mirror when the objective lens is made closer to the mirror.

With the arrangement, the waveplate can be positioned as close as possible to the reflective face of the mirror, so that it is possible to reduce a space necessary for preventing the objective lens holding section from touching the mirror. As a result, it is possible to provide a lens driving device which is made thinner.

It is preferable to arrange the lens driving device according to the present invention so that the cut portion has a concave shape when seen from a bottom face of the objective lens holding section, the bottom face being positioned on a side of the mirror.

With the arrangement, the end of the mirror which end includes a region unusable for the reflective face of the mirror can be stored in the concave portion (space) of the objective lens holding section. As a result, simple modification of the objective lens holding section allows a space necessary for preventing the objective lens holding section from the mirror to be further reduced. Therefore, it is possible to reduce fabrication costs.

It is preferable to arrange the lens driving device according to the present invention so that a cut face of the cut portion is parallel to a focus direction.

With the arrangement, the end of the mirror which includes a region unusable for the reflective face of the mirror can be stored in a space made by providing the cut portion in the objective lens holding section. As a result, simple modification of the objective lens holding section allows a space necessary for preventing the objective lens holding section from touching the mirror to be reduced. Therefore, it is possible to reduce fabrication costs.

It is preferable to arrange the lens driving device according to the present invention so that a cut face of the cut portion is parallel to a tracking direction.

With the arrangement, the end of the mirror which end includes a region unusable for the reflective face of the mirror can be stored in a space made by providing the cut portion in the objective lens holding section. As a result, simple modification of the objective lens holding section allows a space necessary for preventing the objective lens holding section from touching the mirror to be reduced. Therefore, it is possible to reduce fabrication costs.

It is preferable to arrange the lens driving device according to the present invention so that the waveplate is inclined so that an in-plane direction of the waveplate is not perpendicular to an optical axis of the light beam which is incident to the objective lens.

With the arrangement, the end of the mirror which end includes a region unusable for the reflective face of the mirror can be stored in a space made by inclining the waveplate. As a result, simple modification of the objective lens holding section allows a space necessary for preventing the objective lens holding section from touching the mirror to be reduced. Therefore, it is possible to reduce fabrication costs.

Further, the optical pickup device according to the present invention includes the lens driving device. As a result, it is possible to provide an optical pickup device which is made thinner.

Further, the optical recording/reproducing device according to the present invention includes the optical pickup device. As a result, it is possible to provide an optical recording/reproducing device which is made thinner.

As described above, the lens driving device according to the present invention allows reduction of a space necessary for preventing the objective lens holding section from touching the mirror. As a result, it is possible to provide a lens driving device which is made thin. Therefore, the lens driving device according to the present invention is favorably applicable to an optical pickup device or the like. Further, the lens driving device according to the present invention is favorably applicable to an optical recording/reproducing device or the like for recording/reproducing optical information in/from a recording medium such as an optical disc. Therefore, the lens driving device according to the present invention is favorably applicable to various electric products used in homes and industrial equipments.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A lens driving device, which concentrates a light beam emitted by a light source and reflected by a mirror onto a recording layer of a recording medium by use of an objective lens, comprising
an objective lens holding section for holding the objective lens so that the objective lens is movable in an optical axis direction,
wherein
the objective lens holding section includes a cut portion for preventing the objective lens holding section from touching the mirror when the objective lens is made closer to the mirror.

2. A lens driving device, which concentrates a light beam emitted by a light source and reflected by a mirror onto a recording layer of a recording medium by use of an objective lens, comprising:
an objective lens holding section for holding the objective lens so that the objective lens is movable in an optical axis direction; and
a waveplate for shifting a phase of the light beam reflected by the mirror,
wherein
the waveplate is disposed on the objective lens holding section so as to be positioned in a bottom face on a side of the mirror so that the waveplate does not touch the mirror when the objective lens is made closer to the mirror.

3. The lens driving device as set forth in claim 1, wherein the cut portion has a concave shape when seen from a bottom face of the objective lens holding section, the bottom face being positioned on a side of the mirror.

4. The lens driving device as set forth in claim 1, wherein a cut face of the cut portion is parallel to a focus direction.

5. The lens driving device as set forth in claim 1, wherein a cut face of the cut portion is parallel to a tracking direction.

6. The lens driving device as set forth in claim 2, wherein the waveplate is inclined so that an in-plane direction of the waveplate is not perpendicular to an optical axis of the light beam which is incident to the objective lens.

7. An optical pickup device, comprising: a mirror for reflecting a light beam emitted by a light source; and a lens driving device for concentrating the light beam reflected by the mirror onto a recording layer of a recording medium by use of an objective lens, wherein
the lens driving device includes an objective lens holding section for holding the objective lens so that the objective lens is movable in an optical axis direction, and
the objective lens holding section includes a cut portion for preventing the objective lens holding section from touching the mirror when the objective lens is made closer to the mirror.

8. The optical pickup device as set forth in claim 7, wherein:
the mirror includes an end positioned close to the objective lens, and
the objective lens has a summit on a side of the mirror and the summit is positioned closer in a focus direction to a bottom face of the mirror than the end of the mirror when the objective lens holding section is made closest to the mirror.

9. An optical pickup device, comprising:
a mirror for reflecting a light beam emitted by a light source;
a waveplate for shifting a phase of the light beam reflected by the mirror; and
an objective lens for concentrating the light beam whose phase has been shifted by the waveplate onto a recording layer of a recording medium,
wherein
the mirror includes an end positioned close to the objective lens, and
the waveplate includes (i) a mirror-summit-side end positioned close to the end of the mirror and (ii) a light-source-side end which is positioned opposite to the mirror-summit-side end, and
the waveplate is disposed so that the light-source-side end of the waveplate is positioned closer in a focus direction to a bottom face of the mirror than the mirror-summit-side end of the waveplate.

10. The optical pickup device as set forth in claim 9, wherein the light-source-side end of the waveplate is positioned closer in the focus direction to the bottom face of the mirror than the end of the mirror.

11. The optical pickup device as set forth in claim 9, further comprising an objective lens holding section for holding the objective lens so that the objective lens is movable in an optical axis direction.
